(19) United States
(12) Patent Application Publication
(10) Pub. No.: US 2023/0416514 A1
(43) Pub. Date: Dec. 28, 2023

(54) Thermoplastic Resin Composition and Molded Product Using Same

(71) Applicant: LOTTE CHEMICAL CORPORATION, Seoul (KR)

(72) Inventors: Hanna KIM, Uiwang-si (KR); Sanghyun HONG, Uiwang-si (KR); Kyunha BAN, Uiwang-si (KR); Bongjun SONG, Uiwang-si (KR); Wonyoung CHOI, Uiwang-si (KR)

(21) Appl. No.: 18/039,051

(22) PCT Filed: Nov. 24, 2021
(86) PCT No.: PCT/KR2021/017406

§ 371 Date: May 26, 2023

(30) Foreign Application Priority Data
Nov. 30, 2020 (KR) 10-2020-0165042

(51) Int. Cl. C08L 25/12; C08K 5/42

(52) U.S. Cl. CPC C08L 25/12; C08K 5/42; C08L 2207/53; C08L 2205/035; C08L 2203/30

(57) ABSTRACT

Provided are a thermoplastic resin composition and a molded product manufactured therefrom, the thermoplastic resin composition comprising, on the basis of 100 parts by weight of a base resin, (C) 1-10 parts by weight of an aromatic vinyl-vinyl cyanide-maleic anhydride copolymer, (D) 1-15 parts by weight of a polyether-ester-amide block copolymer, and (E) 0.1-5 parts by weight of a trifluoromethane sulfonate metal salt, the base resin comprising (A1) 20-40 wt % of a butadiene-based rubber-modified aromatic vinyl-vinyl cyanide graft copolymer, (A2) 45-65 wt % of an aromatic vinyl-vinyl cyanide copolymer comprising 30-40 wt % of a component derived from a vinyl cyanide compound, and (B) 5-25 wt % of a polyamide resin.

### TECHNICAL FIELD

The present invention relates to a thermoplastic resin composition and a molded product using the same.

### BACKGROUND ART

As a thermoplastic resin, a rubber-modified aromatic vinyl-based copolymer resin, such as an acrylonitrile-butadiene-styrene copolymer resin (ABS resin) and the like, has good properties in terms of mechanical properties, processability, appearance characteristics, and the like to be widely applied to interior/exterior materials for electric/electronic products, automobiles, buildings, and the like.

However, since a plastic product produced from a typical thermoplastic resin exhibits substantially no moisture absorbency in air and allows accumulation of static electricity therein instead of allowing flow of the static electricity, the plastic product can suffer from surface contamination and electrostatic impact due to absorption of dust in air, thereby causing malfunction of devices.

Although an antistatic agent may be used in a thermoplastic resin composition to secure antistatic properties of the thermoplastic resin composition, it is necessary to use an excess of the antistatic agent to secure a suitable level of antistatic properties, causing deterioration in compatibility, heat resistance and the like of the thermoplastic resin composition.

Therefore, there is a need for development of a thermoplastic resin composition that has good properties in terms of antistatic properties, impact resistance, heat resistance, and the like.

### DISCLOSURE

### Technical Problem

Some embodiments of the present invention provide a thermoplastic resin composition that has good properties in terms of antistatic properties, impact resistance, heat resistance, and the like.

Some embodiments of the present invention provide a molded product produced therefrom.

### Technical Solution

In accordance with one aspect of the present invention, a thermoplastic resin composition comprises: 100 parts by weight of a base resin comprising 20 to wt % of (A1) a butadiene-based rubber-modified aromatic vinyl-vinyl cyanide graft copolymer, 45 to 65 wt % of (A2) an aromatic vinyl-vinyl cyanide copolymer containing 30 to 40 wt % of a vinyl cyanide compound-derived component, and 5 to wt % of (B) a polyamide resin; 1 to 10 parts by weight of (C) an aromatic vinyl-vinyl cyanide-maleic anhydride copolymer; 1 to 15 parts by weight of (D) a polyether-ester-amide block copolymer; and 0.1 to 5 parts by weight of (E) a trifluoromethane sulfonate metal salt.

The (A1) butadiene-based rubber-modified aromatic vinyl-vinyl cyanide graft copolymer may have a core-shell structure in which the core is composed of a butadiene-based rubber polymer and the shell is formed by graft polymerization of an aromatic vinyl compound and a vinyl cyanide compound to the core.

The butadiene-based rubber polymer may have an average particle diameter of 0.2 to 1.0 μm.

The (A1) butadiene-based rubber-modified aromatic vinyl-vinyl cyanide graft copolymer may be an acrylonitrile-butadiene-styrene graft (g-ABS) copolymer.

The (A2) aromatic vinyl-vinyl cyanide copolymer may be a styrene-acrylonitrile (SAN) copolymer.

The (A2) aromatic vinyl-vinyl cyanide copolymer may have a weight average molecular weight of 80,000 to 300,000 g/mol.

The (B) polyamide resin may comprise polyamide 6, polyamide 66, polyamide 46, polyamide 11, polyamide 12, polyamide 610, polyamide 612, polyamide 6I, polyamide 6T, polyamide 4T, polyamide 410, polyamide 510, polyamide 1010, polyamide 1012, polyamide 10T, polyamide 1212, polyamide 12T, polyamide MXD6, or a combination thereof.

The (C) aromatic vinyl-vinyl cyanide-maleic anhydride copolymer may be a copolymer comprising 50 to 90 wt % of an aromatic vinyl compound-derived component, 5 to 40 wt % of a vinyl cyanide compound-derived component, and 0.5 to 30 wt % of a maleic anhydride-derived component.

The (C) aromatic vinyl-vinyl cyanide-maleic anhydride copolymer may be a styrene-acrylonitrile-maleic anhydride (SAN-MAH) copolymer.

The (D) polyether-ester-amide block copolymer may be a reaction mixture of: an aminocarboxylic acid, lactam, or diamine-dicarboxylic acid salt having 6 or more carbon atoms; a polyalkylene glycol; and a dicarboxylic acid having 4 to 20 carbon atoms.

The (D) polyether-ester-amide block copolymer and the (E) trifluoromethane sulfonate metal salt may be present in a weight ratio of 1:0.01 to 1:1.5.

In one embodiment, the thermoplastic resin composition may further comprise at least one selected from among flame retardants, nucleating agents, coupling agents, fillers, plasticizers, lubricants, antibacterial agents, release agents, heat stabilizers, antioxidants, UV stabilizers, pigments, and dyes.

In accordance with another aspect of the present invention, there is provided a molded product produced from the thermoplastic resin composition set forth above.

### Advantageous Effects

The present invention provides a thermoplastic resin composition exhibiting good properties in terms of antistatic properties, impact resistance, heat resistance, and the like, and a molded product using the same.

### BEST MODE

Hereinafter, exemplary embodiments of the present invention will be described in detail. However, it should be understood that the following embodiments are provided by way of example and the present invention is not limited thereto and is defined only by the appended claims.

Unless otherwise specified, “copolymerization” means block copolymerization, random copolymerization, or graft copolymerization, and “copolymer” means a block copolymer, a random copolymer, or a graft copolymer.

Unless otherwise specified, the average particle diameter of a rubber polymer is a volume average diameter and means a Z-average particle diameter measured using a dynamic light scattering analyzer.

Unless otherwise specified, the weight average molecular weight is measured on a specimen by gel permeation chromatography (GPC) (1200 series, Agilent Technologies) (column: Shodex LF-804, standard specimen: Shodex polystyrene), in which the specimen is obtained by dissolving a powder specimen in tetrahydrofuran (THF).

According to one embodiment of the present invention, a thermoplastic resin composition comprises: 100 parts by weight of a base resin comprising 20 to wt % of (A1) a butadiene-based rubber-modified aromatic vinyl-vinyl cyanide graft copolymer, 45 to 65 wt % of (A2) an aromatic vinyl-vinyl cyanide copolymer containing 30 to 40 wt % of a vinyl cyanide compound-derived component, and 5 to wt % of (B) a polyamide resin; 1 to 10 parts by weight of (C) an aromatic vinyl-vinyl cyanide-maleic anhydride copolymer; 1 to 15 parts by weight of (D) a polyether-ester-amide block copolymer; and 0.1 to 5 parts by weight of (E) a trifluoromethane sulfonate metal salt.

Hereinafter, each of the components of the thermoplastic resin composition will be described in detail.

(A1) Butadiene-Based Rubber-Modified Aromatic Vinyl-Vinyl Cyanide Graft Copolymer

In one embodiment, the butadiene-based rubber-modified aromatic vinyl-vinyl cyanide graft copolymer imparts good impact resistance to the thermoplastic resin composition. In one embodiment, the butadiene-based rubber-modified aromatic vinyl-vinyl cyanide graft copolymer may have a core-shell structure in which the core is composed of a butadiene-based rubber polymer and the shell is formed by graft polymerization of an aromatic vinyl compound and a vinyl cyanide compound to the core.

The butadiene-based rubber-modified aromatic vinyl-vinyl cyanide graft copolymer may be prepared through graft polymerization of an aromatic vinyl compound and a vinyl cyanide compound to the butadiene-based rubber polymer by a typical polymerization method, such as emulsion polymerization, bulk polymerization, and the like.

The butadiene-based rubber polymer may be selected from the group consisting of a butadiene rubber polymer, a butadiene-styrene rubber polymer, a butadiene-acrylonitrile rubber polymer, a butadiene-acrylate rubber polymer, and mixtures thereof.

The aromatic vinyl compound may be selected from the group consisting of styrene, α-methyl styrene, p-methyl styrene, p-t-butyl styrene, 2,4-dimethyl styrene, chlorostyrene, vinyl toluene, vinyl naphthalene, and mixtures thereof.

The vinyl cyanide compound may be selected from the group consisting of acrylonitrile, methacrylonitrile, fumaronitrile, and mixtures thereof.

The butadiene-based rubber polymer forming the core of the butadiene-based rubber-modified aromatic vinyl-vinyl cyanide graft copolymer may have an average particle diameter of 0.2 to 1.0 μm. For example, the butadiene-based rubber polymer may have an average particle diameter of 0.2 μm or more, 0.3 μm or more, 0.4 μm or more, 0.5 μm or more, 0.6 μm or more, 0.7 μm or more, 0.8 μm or more, or 0.9 μm or more, and 1.0 μm or less, 0.9 μm or less, 0.8 μm or less, 0.7 μm or less, 0.6 μm or less, 0.5 μm or less, 0.4 μm or less, or 0.3 μm or less. Within this range of the average particle diameter of the butadiene-based rubber polymer, the thermoplastic resin composition according to one embodiment and a molded product produced therefrom have good impact resistance and appearance characteristics.

Based on 100 wt % of the butadiene-based rubber-modified aromatic vinyl-vinyl cyanide graft copolymer, the butadiene-based rubber polymer may be present in an amount of 40 to 70 wt %. On the other hand, the aromatic vinyl compound and the vinyl cyanide compound grafted to the core composed of the butadiene-based rubber polymer may be present in a weight ratio of 6:4 to 8:2.

In one embodiment, the butadiene-based rubber-modified aromatic vinyl-vinyl cyanide graft copolymer may be an acrylonitrile-butadiene-styrene graft copolymer.

The butadiene-based rubber-modified aromatic vinyl-vinyl cyanide graft copolymer may be present in an amount of 20 wt % to 40 wt %, for example, 20 wt % or more, 25 wt % or more, 30 wt % or more, or 35 wt % or more, and 40 wt % or less, 35 wt % or less, 30 wt % or less, or 25 wt % or less, based on 100 wt % of the base resin. Within this range of the butadiene-based rubber-modified aromatic vinyl-vinyl cyanide graft copolymer, the thermoplastic resins composition and a molded product produced therefrom can exhibit good impact resistance and heat resistance.

(A2) Aromatic Vinyl-Vinyl Cyanide Copolymer

In one embodiment, the aromatic vinyl-vinyl cyanide copolymer serves to improve fluidity of the thermoplastic resin composition while securing a predetermined level of compatibility between the components thereof.

In one embodiment, the aromatic vinyl-vinyl cyanide copolymer may have a weight average molecular weight of 80,000 to 300,000 g/mol, for example, 80,000 to 200,000 g/mol, for example, 80,000 to 150,000 g/mol, for example, 80,000 g/mol or more, 85,000 g/mol or more, 90,000 g/mol or more, 100,000 g/mol or more, 120,000 g/mol or more, 150,000 g/mol or more, 200,000 g/mol or more, or 250,000 g/mol or more, and 300,000 g/mol or less, 250,000 g/mol or less, 200,000 g/mol or less, 150,000 g/mol or less, or 100,000 g/mol or less.

In one embodiment, the aromatic vinyl-vinyl cyanide copolymer may be prepared through polymerization of a monomer mixture comprising an aromatic vinyl compound and a vinyl cyanide compound by a typical polymerization method, such as emulsion polymerization, suspension polymerization, solution polymerization, bulk polymerization, and the like.

The aromatic vinyl compound may be selected from the group consisting of styrene, α-methyl styrene, p-methyl styrene, p-t-butyl styrene, 2,4-dimethyl styrene, chlorostyrene, vinyl toluene, vinyl naphthalene, and mixtures thereof.

The vinyl cyanide compound may be selected from the group consisting of acrylonitrile, methacrylonitrile, fumaronitrile, and mixtures thereof.

The aromatic vinyl-vinyl cyanide copolymer may comprise a component derived from the aromatic vinyl compound in an amount of 30 to 40 wt %, for example, 30 wt % or more, 32 wt % or more, 34 wt % or more, 36 wt % or more, or 38 wt % or more, and 40 wt % or less, 38 wt % or less, 36 wt % or less, 34 wt % or less, or 32 wt % or less, based on 100 wt %.

In one embodiment, the aromatic vinyl-vinyl cyanide copolymer may be a styrene-acrylonitrile (SAN) copolymer.

In one embodiment, the aromatic vinyl-vinyl cyanide copolymer may be present in an amount of 45 to 65 wt %, for example, 45 wt % or more, 50 wt % or more, 55 wt % or more, or 60 wt % or more, and 65 wt % or less, 60 wt % or less, 55 wt % or less, or 50 wt % or less, based on 100 wt % of the base resin. Within this range of the aromatic vinyl-vinyl cyanide copolymer, the thermoplastic resins composition and a molded product produced therefrom can exhibit good formability and mechanical properties.

(B) Polyamide Resin

In one embodiment, the polyamide resin allows the thermoplastic resin composition to realize good electrical conductivity. For example, even without an excess of the (D) polyether-ester-amide block copolymer added to impart electrical conductivity to the thermoplastic resin composition, the thermoplastic resin composition according to one embodiment can exhibit good electrical conductivity when containing the polyamide resin.

In one embodiment, the polyamide resin may be selected from various polyamide resins known to those skilled in the art and may include, for example, an aromatic polyamide resin, an aliphatic polyamide resin, or a mixture thereof, without being limited thereto.

The aromatic polyamide resin is a polyamide having an aromatic group in a main chain and may be a wholly-aromatic polyamide, a semi-aromatic polyamide, or a mixture thereof.

The wholly-aromatic polyamide means a polymer of an aromatic diamine and an aromatic dicarboxylic acid, and the semi-aromatic polyamide means an aromatic polyamide containing at least one aromatic unit and at least one non-aromatic unit between amide bonds. For example, the semi-aromatic polyamide may be a polymer of an aromatic diamine and an aliphatic dicarboxylic acid or a polymer of an aliphatic diamine and an aromatic dicarboxylic acid.

The aliphatic polyamide means a polymer of an aliphatic diamine and an aliphatic dicarboxylic acid.

The aromatic diamine may include, for example, p-xylene diamine, m-xylene diamine, and the like, without being limited thereto. These may be used alone or as a mixture thereof.

The aromatic dicarboxylic acid may include, for example, phthalic acid, isophthalic acid, terephthalic acid, 2,6-naphthalenedicarboxylic acid, (1,3-phenylenedioxy)diacetic acid, and the like, without being limited thereto. These may be used alone or as a mixture thereof.

The aliphatic diamine may include, for example, ethylenediamine, trimethylenediamine, hexamethylenediamine, dodecamethylenediamine, piperazine, and the like, without being limited thereto. These may be used alone or as a mixture thereof.

The aliphatic dicarboxylic acid may include, for example, adipic acid, sebacic acid, succinic acid, glutaric acid, azelaic acid, dodecanedioic acid, dimeric acid, cyclohexanedicarboxylic acid, and the like, without being limited thereto. These may be used alone or as a mixture thereof.

In one embodiment, the polyamide resin may comprise polyamide 6, polyamide 66, polyamide 46, polyamide 11, polyamide 12, polyamide 610, polyamide 612, polyamide 6I, polyamide 6T, polyamide 4T, polyamide 410, polyamide 510, polyamide 1010, polyamide 1012, polyamide 10T, polyamide 1212, polyamide 12T, polyamide MXD6, or a combination thereof.

In one embodiment, the polyamide resin may comprise at least polyamide 6.

In one embodiment, the polyamide resin may be present in an amount of 5 to 25 wt %, for example, 5 to 20 wt %, for example, 5 to 15 wt %, for example, 5 to 20 wt %, for example, 10 to 25 wt %, based on 100 wt % of the base resin.

Within this range of the polyamide resin, the thermoplastic resins composition and a molded product produced therefrom can exhibit good mechanical properties and electrical conductivity.

(C) Aromatic Vinyl-Vinyl Cyanide-Maleic Anhydride Copolymer

In one embodiment, the aromatic vinyl-vinyl cyanide-maleic anhydride copolymer serves to improve impact resistance of the thermoplastic resin composition.

In one embodiment, the aromatic vinyl-vinyl cyanide-maleic anhydride copolymer may be prepared through polymerization of a monomer mixture comprising an aromatic vinyl compound, a vinyl cyanide compound, and a maleic anhydride by a typical polymerization method, such as emulsion polymerization, suspension polymerization, solution polymerization, bulk polymerization, and the like.

The aromatic vinyl-vinyl cyanide-maleic anhydride copolymer may be present in any copolymerization form and may have a structure in which an aromatic vinyl compound-derived component, a vinyl cyanide compound-derived component, and a maleic anhydride-derived component constitute an alternating copolymer, a random copolymer, or a block copolymer, or a structure in which the maleic anhydride-derived component is grafted to a main chain to which the aromatic vinyl compound-derived component and the vinyl cyanide compound-derived component are copolymerized.

The aromatic vinyl-vinyl cyanide-maleic anhydride copolymer may comprise 50 to 90 wt % of the aromatic vinyl compound-derived component, 5 to 40 wt % of the vinyl cyanide compound-derived component, and 0.5 to 30 wt % of the maleic anhydride-derived component, based on 100 wt %. Within this range, the thermoplastic resin composition and a molded product produced therefrom can exhibit good impact resistance.

The aromatic vinyl compound may be selected from the group consisting of styrene, α-methyl styrene, p-methyl styrene, p-t-butyl styrene, 2,4-dimethyl styrene, chlorostyrene, vinyl toluene, vinyl naphthalene, and mixtures thereof.

The vinyl cyanide compound may be selected from the group consisting of acrylonitrile, methacrylonitrile, fumaronitrile, and mixtures thereof.

The aromatic vinyl-vinyl cyanide-maleic anhydride copolymer may be a styrene-acrylonitrile-maleic anhydride copolymer.

In one embodiment, the aromatic vinyl-vinyl cyanide-maleic anhydride copolymer may be present in an amount of 1 to 10 parts by weight, for example, 1 part by weight or more, 3 parts by weight or more, 5 parts by weight or more, 7 parts by weight or more, or 9 parts by weight or more, and 10 parts by weight or less, 8 parts by weight or less, 6 parts by weight or less, 4 parts by weight or less, or 2 parts by weight, relative to 100 parts by weight of the base resin. Within this range of the aromatic vinyl-vinyl cyanide-maleic anhydride copolymer, the thermoplastic resin composition and a molded product produced therefrom can exhibit good impact resistance.

(D) Polyether-Ester-Amide Block Copolymer

In one embodiment, the polyether-ester-amide block copolymer allows the thermoplastic resin composition and a molded product produced therefrom to exhibit good electrical conductivity.

In one embodiment, the polyether-ester-amide block copolymer may be, for example, a reaction mixture comprising an amino-carboxylic acid, lactam or diamine-dicarboxylic acid salt having 6 or more carbon atoms; a polyalkylene glycol; and a dicarboxylic acid having 4 to 20 carbon atoms.

In one embodiment, the aminocarboxylic acid, lactam, or diamine-dicarboxylic acid salt having 6 or more carbon atoms may include aminocarboxylic acids, such as ω-aminocaproic acid, ω-aminoenanthic acid, ω-aminocaprylic acid, ω-aminopelargonic acid, ω-aminocapric acid, 11-aminoundecanoic acid, 12-aminododecanoic acid, and the like; lactams, such as ε-caprolactam, enantolactam, capryl lactam, laurolactam, and the like; and salts of diamines and dicarboxylic acids, such as salts of hexamethylenediamine-adipic acid, salts of hexamethylenediamine-isophthalic acid, and the like. For example, 12-aminododecanoic acid, ε-caprolactam, and salts of hexamethylenediamine-adipic acid, and the like may be used.

In one embodiment, the polyalkylene glycol may include polyethylene glycol, polytetramethylene glycol, polyhexamethylene glycol, a block or random copolymer of ethylene glycol and propylene glycol, a copolymer of ethylene glycol and tetrahydrofuran, and the like. For example, polyethylene glycol, a copolymer of ethylene glycol and propylene glycol, and the like may be used.

In one embodiment, the dicarboxylic acid having 4 to 20 carbon atoms may include terephthalic acid, 1,4-cyclohexanedicarboxylic acid, sebacic acid, adipic acid, dodecanedioic acid, and the like.

In one embodiment, a bond between the aminocarboxylic acid, lactam or diamine-dicarboxylic acid salt having 6 or more carbon atoms and the polyalkylene glycol may be an ester bond; a bond between the aminocarboxylic acid, lactam or diamine-dicarboxylic acid salt having 6 or more carbon atoms and the dicarboxylic acid having 4 to 20 carbon atoms may be an amide bond; and a bond between the polyalkylene glycol and the dicarboxylic acid having 4 to 20 carbon atoms may be an ester bond.

In one embodiment, the polyether-ester-amide block copolymer may be prepared by a method well-known in the art, for example, by a method disclosed in JP Patent Publication No. S56-045419 or JP Unexamined Patent Publication No. S55-133424.

In one embodiment, the polyether-ester-amide block copolymer may comprise 10 to about 95 wt % of a polyether-ester block. Within this range, the thermoplastic resin composition can exhibit good electrical conductivity, heat resistance, and the like.

In one embodiment, the polyether-ester-amide block copolymer may be present in an amount of 1 to 15 parts by weight, for example, 1 part by weight or more, 5 parts by weight or more, or 10 parts by weight or more, and 15 parts by weight or less, 10 parts by weight or less, or 5 parts by weight or less, relative to 100 parts by weight of the base resin. Within this range of the polyether-ester-amide block copolymer, the thermoplastic resin composition and a molded product produced therefrom can exhibit good electrical conductivity while maintaining good waterproof reliability.

(E) Trifluoromethane Sulfonate Metal Salt

In one embodiment, the trifluoromethane sulfonate metal salt serves to improve antistatic properties and the like of the thermoplastic resin composition together with the (D) polyether-ester-amide block copolymer.

Conventionally, KR 10-1971804 B1 and the like disclose use of potassium perfluorobutane sulfonate and the like in the thermoplastic resin composition to improve antistatic properties of the thermoplastic resin composition. However, it is anticipated that there will be difficulty in using potassium perfluorobutane sulfonate due to recent issues as to toxicity of potassium perfluorobutane sulfonate in Europe and the like.

The inventors of the present invention have found that a trifluoromethane sulfonate metal salt does not have toxicity and can achieve an effect equivalent to or better than potassium perfluorobutane sulfonate.

That is, when the (E) trifluoromethane sulfonate metal salt is contained in the thermoplastic resin composition, it is possible to prepare a thermoplastic resin composition, which does not exhibit toxicity while exhibiting good antistatic properties, and a molded product produced therefrom.

The (E) trifluoromethane sulfonate metal salt may comprise sodium, lithium, or a combination thereof.

The (E) trifluoromethane sulfonate metal salt may be present in an amount of 0.1 to 5 parts by weight, for example, 0.1 to 4 parts by weight, 0.1 to 3.5 parts by weight, 0.1 to 3 parts by weight, 0.1 to 2.5 parts by weight, 0.1 to 2 parts by weight, 0.1 to 1.5 parts by weight, 0.1 to 1 part by weight, 0.1 to 0.5 parts by weight, or 0.2 to 0.5 parts by weight, relative to 100 parts by weight of the base resin. Within this content of the trifluoromethane sulfonate metal salt, the thermoplastic resin composition and a molded product produced therefrom can exhibit good antistatic properties.

In one embodiment, the (D) polyether-ester-amide block copolymer and the (E) trifluoromethane sulfonate metal salt may be present in a weight ratio ((D):(E)) of 1:0.01 to 1:1.5. For example, the (D) polyether-ester-amide block copolymer and the (E) trifluoromethane sulfonate metal salt may be present in a weight ratio ((D):(E)) of 1:0.01 to 1:1, 1:0.01 to 1:0.5, or 1:0.01 to 1:0.1. Within this range, the thermoplastic resin composition and a molded product produced therefrom can exhibit good properties in terms of antistatic properties, impact resistance, and the like.

(F) Additive

In addition to the components (A1) to (E), the thermoplastic resin composition according to one embodiment may further comprise at least one type of additive in order to secure property balance while securing good properties in terms of antistatic properties, impact resistance, and heat resistance, or according to final purpose of the thermoplastic resin composition, as needed.

Specifically, the additives may include flame retardants, nucleating agents, coupling agents, fillers, plasticizers, lubricants, antibacterial agents, release agents, heat stabilizers, antioxidants, UV stabilizers, pigments, dyes, and the like. These may be used alone or in combination thereof.

These additives may be present in a suitable amount within the range not causing deterioration in properties of the thermoplastic resin composition, specifically in an amount of 20 parts by weight or less relative to 100 parts by weight of the base resin, without being limited thereto.

The thermoplastic resin composition according to the present invention may be prepared by a typical method known to those skilled in the art.

For example, the thermoplastic resin composition according to the present invention may be prepared in pellet form by simultaneously mixing the aforementioned components of the present invention and other additives, followed by melt kneading in an extruder.

Another embodiment of the present invention provides a molded product produced from the thermoplastic resin composition according to the embodiments of the present invention. The molded product may be produced from the thermoplastic resin composition by various methods known in the art, such as injection molding, extrusion molding, and the like.

As such, the molded product has good properties in terms of antistatic properties, impact resistance, heat resistance, and the like, and thus can be advantageously applied to various electric/electronic products, building materials, sports products, and interior/exterior parts of automobiles.

Next, the present invention will be described in more detail with reference to some examples. It should be understood that these examples are provided for illustration only and are not to be in any way construed as limiting the present invention.

### Examples 1 and 2 and Comparative Examples 1 to 4

Thermoplastic resin compositions of Examples 1 and 2 and Comparative Examples 1 to 4 were prepared in composition ratios as listed in Table 1.

In Table 1, (A1), (A2), (AT), and (B) are included in a base resin and are represented in wt % based on the total weigh of the base resin, and (C), (D) and (E) included in a base resin is represented in parts by weight relative to 100 parts by weight of the base resin.

The components listed in Table 1 were continuously supplied in quantitative amounts to a supply part (barrel temperature: about 240° C.) of a twin-screw extruder (L/D=36, Φ=45 mm), followed by extrusion/machining, thereby preparing a thermoplastic resin composition in pellet form. Then, specimens for evaluation of properties were prepared by drying the thermoplastic resin composition prepared in pellet form at 80° C. for about 2 hours, followed by injection molding using a 6 oz injection molding machine at a cylinder temperature of about 240° C. and a mold temperature of about 60° C.

TABLE 1

| | | | | Comparative | Comparative | Comparative | Comparative |
|---|---|---|---|---|---|---|---|
| Item | | Example 1 | Example 2 | Example 1 | Example 2 | Example 3 | Example 4 |
| (A1) | wt % | 30 | 30 | 30 | 30 | 30 | 30 |
| (A2) | wt % | 55 | 55 | 55 | 55 | — | 55 |
| (A2′) | wt % | — | — | — | — | 55 | — |
| (B) | wt % | 15 | 15 | 15 | 15 | 15 | 15 |
| (C) | parts by | 4 | 4 | 4 | 4 | 4 | — |
| | weight | | | | | | |
| (D) | parts by | 6 | 8 | 6 | 8 | 8 | 8 |
| | weight | | | | | | |
| (E) | parts by | 0.5 | 1.0 | — | — | 1.0 | — |
| | weight | | | | | | |

(A1) Butadiene-Based Rubber-Modified Aromatic Vinyl-Vinyl Cyanide Graft Copolymer

An acrylonitrile-butadiene-styrene graft copolymer (Lotte Chemical Corp.) comprising about 45 wt % of a core (average particle diameter: about 0.31 μm) composed of a butadiene rubber polymer and a shell formed by graft polymerization of styrene and acrylonitrile (styrene/acrylonitrile weight ratio: about 75/25) to the core was used.

(A2) Aromatic Vinyl-Vinyl Cyanide Copolymer

A styrene-acrylonitrile copolymer (Lotte Chemical Corp.) prepared through copolymerization of a monomer mixture comprising 65 wt % of styrene and 35 wt % of acrylonitrile and having a weight average molecular weight of about 100,000 g/mol was used.

(A2′) Aromatic Vinyl-Vinyl Cyanide Copolymer

A styrene-acrylonitrile copolymer (Lotte Chemical Corp.) prepared through copolymerization of a monomer mixture comprising 75 wt % of styrene and 25 wt % of acrylonitrile and having a weight average molecular weight of about 105,000 g/mol was used.

(B) Polyamide Resin

Polyamide 6 (EN-300, KP ChemTech Co., Ltd.) was used.

(C) Aromatic Vinyl-Vinyl Cyanide-Maleic Anhydride Copolymer

A styrene-acrylonitrile-maleic anhydride copolymer (SAM-010, Fine Blend Polymer Co., Ltd.) was used.

(D) Polyether-Ester-Amide Block Copolymer

A polyamide 6-polyethylene oxide block copolymer (PELECTRON AS, Sanyo Chemical Ind., Ltd.) was used.

(E) Trifluoromethane Sulfonate Metal Salt

Lithium trifluoromethane sulfonate (Sigma-Aldrich) was used.

### Experimental Example

The following properties were measured on each of specimens for evaluation prepared in Examples 1 and 2 and Comparative Examples 1 to 4 and evaluation results are shown in Table 2.

(1) Antistatic properties (unit: Ω/sq): Surface resistance was measured on a specimen having a size of 100 mm×100 mm×2 mm using a surface resistance meter (Manufacturer: SIMCO-ION, Model: Work surface tester ST-4) in accordance with ASTM D257. Lower surface resistance indicates better electrical conductivity.

(2) Impact resistance (unit: kgf·cm/cm): Notched Izod impact strength was measured on a ¼″ thick specimen in accordance with ASTM D256.

(3) Heat resistance (unit: ° C.): Vicat softening temperature (VST) was measured on a 6.4 mm thick specimen in accordance with ASTM D1525.

TABLE 2

| | | | Comparative | Comparative | Comparative | Comparative |
|---|---|---|---|---|---|---|
| Property | Example 1 | Example 2 | Example 1 | Example 2 | Example 3 | Example 4 |
| Surface resistance | 10^{10.2} | 10^{9.9} | 10^{11.0} | 10^{10.6} | 10^{10.2} | 10^{10.6} |
| Izod impact | 52 | 51 | 54 | 51 | 42 | 35 |
| strength | | | | | | |
| VST | 95 | 96 | 95 | 95 | 94 | 95 |

From Tables 1 and 2, it could be seen that the thermoplastic resin compositions of Examples exhibited good properties in terms of antistatic properties, impact resistance, and heat resistance.

Although some exemplary embodiments have been described above, it should be understood that the present invention is not limited thereto and various modifications, changes, alterations, and equivalent embodiments can be made by those skilled in the art without departing from the spirit and scope of the invention.

Please amend the claims as follows prior to the calculation of the claim fees:

1. A thermoplastic resin composition comprising:
100 parts by weight of a base resin comprising 20 to 40 wt % of (A1) a butadiene-based rubber-modified aromatic vinyl-vinyl cyanide graft copolymer, 45 to 65 wt % of (A2) an aromatic vinyl-vinyl cyanide copolymer containing 30 to 40 wt % of a vinyl cyanide compound-derived component, and 5 to 25 wt % of (B) a polyamide resin;
1 to 10 parts by weight of (C) an aromatic vinyl-vinyl cyanide-maleic anhydride copolymer;
1 to 15 parts by weight of (D) a polyether-ester-amide block copolymer; and
to 5 parts by weight of (E) a trifluoromethane sulfonate metal salt.

2. The thermoplastic resin composition according to claim 1, wherein the (A1) butadiene-based rubber-modified aromatic vinyl-vinyl cyanide graft copolymer has a core-shell structure in which the core is composed of a butadiene-based rubber polymer and the shell is formed by graft polymerization of an aromatic vinyl compound and a vinyl cyanide compound to the core.

3. The thermoplastic resin composition according to claim 2, wherein the butadiene-based rubber polymer has an average particle diameter of 0.2 to 1.0 μm.

4. The thermoplastic resin composition according to claim 1, wherein the (A1) butadiene-based rubber-modified aromatic vinyl-vinyl cyanide graft copolymer is an acrylonitrile-butadiene-styrene graft (g-ABS) copolymer.

5. The thermoplastic resin composition according to claim 1, wherein the (A2) aromatic vinyl-vinyl cyanide copolymer is a styrene-acrylonitrile (SAN) copolymer.

6. The thermoplastic resin composition according to claim 1, wherein the (A2) aromatic vinyl-vinyl cyanide copolymer has a weight average molecular weight of 80,000 to 300,000 g/mol.

7. The thermoplastic resin composition according to claim 1, wherein the (B) polyamide resin comprises polyamide 6, polyamide 66, polyamide 46, polyamide 11, polyamide 12, polyamide 610, polyamide 612, polyamide 6I, polyamide 6T, polyamide 4T, polyamide 410, polyamide 510, polyamide 1010, polyamide 1012, polyamide polyamide 1212, polyamide 12T, polyamide MXD6, or a combination thereof.

8. The thermoplastic resin composition according to claim 1, wherein the (C) aromatic vinyl-vinyl cyanide-maleic anhydride copolymer is a copolymer comprising 50 to 90 wt % of an aromatic vinyl compound-derived component, 5 to 40 wt % of a vinyl cyanide compound-derived component, and 0.5 to 30 wt % of a maleic anhydride-derived component.

9. The thermoplastic resin composition according to claim 1, wherein the (C) aromatic vinyl-vinyl cyanide-maleic anhydride copolymer is a styrene-acrylonitrile-maleic anhydride copolymer.

10. The thermoplastic resin composition according to claim 1, wherein the (D) polyether-ester-amide block copolymer is a reaction mixture of: an aminocarboxylic acid, lactam, or diamine-dicarboxylic acid salt having 6 or more carbon atoms; a polyalkylene glycol; and a dicarboxylic acid having 4 to 20 carbon atoms.

11. The thermoplastic resin composition according to claim 1, wherein the (D) polyether-ester-amide block copolymer and the (E) trifluoromethane sulfonate metal salt are present in a weight ratio of 1:0.01 to 1:1.5.

12. The thermoplastic resin composition according to claim 1, further comprising: at least one additive selected from flame retardants, nucleating agents, coupling agents, fillers, plasticizers, lubricants, antibacterial agents, release agents, heat stabilizers, antioxidants, UV stabilizers, pigments, and dyes.

13. A molded product produced from the thermoplastic resin composition according to claim 1.
